(19) United States
(12) Patent Application Publication
(10) Pub. No.: US 2006/0121072 A1
(43) Pub. Date: Jun. 8, 2006

(54) Topical parasiticide formulations and methods of treatment

(76) Inventor: Stanley Shepherd, Ingleburn (AU)

Correspondence Address: SCHERING-PLOUGH CORPORATION;PATENT DEPARTMENT (K-6-1, 1990), 2000 GALLOPING HILL ROAD, KENILWORTH, NJ, 07033-0530, US

(21) Appl. No.: 10/534,302

(22) PCT Filed: Nov. 11, 2003
(86) PCT No.: PCT/AU03/01490

§ 371 Date: Oct. 21, 2005

(30) Foreign Application Priority Data
Nov. 11, 2002 (AU) 2002952597

(51) Int. Cl. A01N 43/52; A01N 25/00; A01N 43/04

(52) U.S. Cl. 424/405; 514/28; 514/394

(57) ABSTRACT

The present invention discloses aqueous micellar formulations for topical administration of benzimidazoles or salicylanilides with macrocyclic lactones to livestock for the control of endo- and ecto-parasites, comprising a first active agent selected from water insoluble benzimidazoles, salicylanilides and active derivatives or salts thereof, in combination with a second active agent selected from macrocyclic lactones or active derivatives or salts thereof, and also comprising, per litre of formulation: from about 100 to about 400 g veterinary acceptable surfactant(s); from about 200 to about 750 g veterinary acceptable water-miscible solvent(s); and from about 50 to about 350 g water, as well as methods for dosing livestock with such formulations, and methods for controlling and/or preventing diseases or parasite infection in livestock.

### TECHNICAL FIELD

This invention relates to formulations for administration of benzimidazoles or salicylanilides with macrocyclic lactones to livestock for the control of endo- and/or ecto-parasites, methods for dosing livestock with such formulations, and methods for controlling and/or preventing diseases or parasite infection in livestock.

### BACKGROUND ART

A number of formulations containing active components, such as therapeutic, prophylactic and/or bioactive substances, for the treatment and/or prophylaxis of diseases or parasite infection in livestock, are known. Such formulations include tablets and solutions for oral administration, injectable solutions, treated collars and ear-tags, and topical means, including pour-on and spot-on formulations.

Many of the early such formulations were intended for topical treatment/prophylaxis of ectoparasite-related conditions, designed to spread the active component over the skin and/or hair surfaces of the animal, not to administer the active component(s) to the bloodstream of the animal being treated. More recently, endoparasiticide pour-on formulations for delivery of particular active agents, including macrocyclic lactones, to the bloodstream of domestic animals, such as sheep and cattle, have been developed, and these have the advantage over other administration forms, such as oral drenches and injection, of being easily applied to animals in a relatively-accurate amount.

Known pour-on and spot-on formulations for endoparasiticide treatment generally utilise a non-aqueous delivery system for administering active components to animals, since the active ingredients of interest were substantially water-insoluble (particularly macrocyclic lactones, levamisole base, benzimidazoles), and it was believed that dissolution of the parasiticide was necessary in order for the parasiticide to become systemically absorbed.

Commercial ectoparasiticide products are available as both solvent-based and aqueous-based formulations. Water-insoluble actives have been formulated as aqueous suspension pour-on formulations, e.g., deltamethrin (a synthetic pyrethroid) for the treatment of lice on sheep (Clout S®, Schering-Plough) and cattle (Coopers® Easy Dose, Schering-Plough), and diflubenzuron (insect growth regulator, or IGR) for lice on sheep (Magnum IGR®, Schering-Plough). These treatments are characterised by low levels of actives found in tissues following treatment, reflecting little penetration of active through the skin layer. Solvent-based formulations containing the water-insoluble IGR, triflumuron (e.g., Zapp), Bayer) for lice control on sheep are also available. At an equivalent dose rate to the aqueous-based formulations, these solvent-based formulations lead to higher tissue residues immediately after treatment. This supports the assertion that a water-insoluble active will be more easily systemically absorbed if it is solubilized in the formulation.

By ‘water-insoluble’, it is meant that the water solubility is insufficient for an effective amount of an endoparasiticide to be dissolved in a commercially-viable dose of a water-based pour-on formulation. Practically, a dose of pour-on formulation should not be much more than 1.0 mL/10 kg bodyweight (for ease of application and to prevent runoff). At this rate, a 500 kg beast would receive a 50 mL dose, therefore, a 2.0 mL/10 kg dose is not practical, as many animals weigh much more than 500 kg.

Benzimidazoles and macrocyclic lactones are important classes of agents for the treatment or prevention of a number of important endoparasites of livestock, including acute or chronic liver fluke disease, best recognized in sheep and cattle, caused by the liver parasite Fasciola hepatica, and nematodes such as the Cooperia, Ostertagia, and Trichostrongylus species.

Triclabendazole is a particularly effective benzimidazole, and is the most effective drug currently available against all stages of Fasciola hepatica, destroying the early immature and immature fluke migrating through the liver, as well as the adult fluke in the bile duct.

Salicylanilide compounds form another important class of agents for control of endoparasites, particularly Fasciola hepatica, and nematodes, such as Haemonchus species. The salicylanilide oxyclozanide is effective against adult liver fluke (Fasciola hepatica) and immature paramphistones migrating in the intestine of cattle and the young flukes in the rumen and reticulum. Oxyclozanide is highly insoluble in water and is administered to animals in an aqueous suspension formulation by oral dosing.

Commercial endectocide pour-on products containing the avermectins, ivermectin (Paramax®, Schering-Plough, Ivomec® Cattle Pour-On, Merial), moxidectin (Cydectin®, Fort Dodge) and doramectin (Dectomax®, Pfizer), are currently available for treatment of cattle for the control or prophylaxis of a number of endo- and ectoparasites, such as lice, flies and ticks. These formulations, however, require significantly higher administration rates of the active component, as compared to oral drenching techniques, typically at least two times the oral drenching rates, in order to achieve effective blood concentrations of the active ingredient in the animal, and to achieve the same efficacy of treatment. For example, ivermectin oral solution for cattle (Ivomec® Oral Solution for Cattle, Merial, registered in New Zealand) has a dose rate of 200 micrograms ivermectin/kg bodyweight, whereas Ivomec® Cattle Pour-On has a dose rate of 500 micrograms ivermectin/kg bodyweight.

Treatment of liver fluke in cattle with anthelmintics, such as triclabendazole, is generally carried out by oral drenching with a commercial product, for example Fasinex® 120 (120 g/L triclabendazole, Novartis), as well as by injection (Ivomec® Plus Antiparasitic Injection for cattle, Merial, which also controls adult liver fluke).

Pour-on or spot-on formulations of salicylanilide derivatives are not currently available, usually being administered to livestock by oral drench.

It would be highly desirable, in order to provide broad-spectrum protection against endoparasites and ectoparasites, through efficient delivery of water-insoluble compounds, such as benzimidazoles or salicylanilides, in combination with macrocyclic lactones to the bloodstream of animals by a single, convenient topical application, rather than by oral administration.

By “efficient delivery”, it is meant that the active agent is administered at a rate approximating oral dosage rates, up to about twice normal oral dosage rates, to give effective blood concentrations and equivalent efficacy.

International Publication No. WO00/61068 (PCT/NZ00/00053) discloses triclabendazole, optionally in combination with a macrocyclic lactone, dissolved in at least one solvent, preferably administered as a pour-on formulation for control of liver fluke. Efficacy data supplied (based on a low natural infection fluke challenge, mean of 20), however, shows that the formulation was applied at 2.5 times the dose of a standard oral drench rate to give equivalent efficacy. Also, two of the solvents described, xylene and toluene, are highly flammable. The reported triclabendazole content of the formulation, after 345 days storage at ambient temperature, is 7.5% lower than the initial assay, although there is no decrease in the abamectin content. Solvent-based formulations of ivermectin can break down rapidly unless suitably stabilized.

A solvent-based, topically-administered formulation of the salicylanilide closantel with the macrocyclic lactone ivermectin, for the control of parasites, has been described in U.S. Pat. No. 6,340,672. The maximum concentration of active agents described in the examples of this document is 0.5% w/v for ivermectin and 5% w/v for closantel. At these concentrations, unacceptably large volumes of the formulations (from a practical viewpoint) would need to be poured onto the animals in order to achieve effective blood concentrations of the active agents.

WO 00/74489 (PCT/NZ00/00087) discloses biocidal compositions, including pour-on formulations which are water-in-oil (soyabean) emulsions stabilized with an emulsifying agent. The formulations comprise the water-soluble anthelmintic, levamisole (as the hydrochloride salt), and a macrocyclic lactone (abamectin or ivermectin), optionally in combination with a benzimidazole (oxfendazole). Only low levels of benzimidazole are present in the formulations disclosed in this document (up to 5% w/v oxfendazole in an oral drench formulation), and only one pour-on formulation comprising a benzimidazole (2.26% w/v oxfendazole) and a macrocyclic lactone (0.1% w/v abamectin) is disclosed. Whilst this pour-on formulation is described as delivering the levamisole to the bloodstream of cattle with efficiency similar to oral drench administration, the macrocyclic lactones and benzimidazoles were delivered with low efficiency and a commercially-unpractical volume of this formulation would be required to be applied to animals in order to achieve effective blood concentrations of these actives.

### OBJECTS OF THE INVENTION

It is an object of this invention to provide a topical formulation capable of efficient delivery of a benzimidazole or salicylanilide, in combination with a macrocyclic lactone, to the bloodstream of an animal for broad-spectrum control of endoparasites, such as liver fluke and nematodes, in animals, such as sheep and cattle, with a single, easily-applied topical formulation.

### SUMMARY OF THE INVENTION

It has now been surprisingly found that a benzimidazole or a salicylanilide, in combination with a macrocyclic lactone, may be formulated into a stable aqueous micellar composition which, when applied topically to an animal, efficiently delivers the desired active constituents to the bloodstream of the animal, and provides effective protection against infestation by endoparasites such as liver fluke and nematodes.

Thus, the present invention provides an aqueous micellar formulation comprising a first active agent selected from benzimidazoles, salicylanilides and active derivatives or salts thereof, in combination with a second active agent selected from macrocyclic lactones or active derivatives or salts thereof, said formulation being for topical application to animals for the control of internal parasites and also comprising, per litre of formulation:
from about 100 g to about 400 g veterinary-acceptable surfactant(s);
from about 200 g to about 750 g veterinary-acceptable water-miscible solvent(s); and
from about 50 g to about 350 g water.

Surprisingly, it has also been found that the stability of aqueous micellar formulations of the invention may be improved by inclusion of a stabilizer selected from anionic surfactants, such as sodium dodecyl sulphate (SDS), and/or buffering agents, such as soluble phosphates and/or dibasic phosphates.

Thus, in a preferred aspect of the invention, the aqueous micellar formulation comprises a stabilizer selected from anionic surfactants or buffering agents, or mixtures thereof. Preferably the stabilizer is a linear alkyl sulphate, such as sodium dodecyl sulphate, or one or more phosphates/dibasic phosphates, or mixtures thereof.

In a preferred embodiment, there is provided an aqueous micellar formulation comprising a benzimidazole in combination with a macrocyclic lactone, said formulation being for topical application to animals for the control of internal parasites and also comprising, per litre of formulation:
about 100 g to about 300 g polyoxyalkylene sorbitan fatty acid ester surfactant;
about 300 g to about 650 g alkylene glycol ether selected from alkylene or dialkylene glycol monoalkyl ethers or combinations thereof;
about 10 g to about 100 g polyethylene glycol;
about 5 g to about 50 g stabilizer; and
about 50 g to about 350 g water.

In a particularly preferred aspect of this embodiment, the formulation comprises, per litre formulation:
about 180 g to about 240 g benzimidazole;
about 7.5 g to about 20 g macrocyclic lactone or an active derivative or salt thereof;
about 150 g to about 250 g polyoxyethylene (20) sorbitan monolaurate;
about 450 g to about 550 g diethylene glycol monobutyl ether;
about 20 g to about 50 g PEG 200;
about 20 g sodium dodecyl sulphate; and
about 100 g to about 200 g water.

The invention also provides a method of treating or preventing a diseased or parasite-infested state in a mammal, comprising topically administering to said mammal a micellar formulation according to the instant invention.

Typically, the diseased or infested state is related to liver fluke, such as caused by Fasciola hepatica, and nematodes, such as Cooperia, Ostertagia, Trichostrongylus and Haemonchus species, or combinations thereof.

Even more typically, the diseased or infested state to be treated or prevented is a disease or infested state of cattle or sheep, more typically cattle.

Surprisingly, it was found that the location and size of the region of topical administration of the formulations was important for efficiency of permeation of the active agents across the skin into the bloodstream.

Thus, in a preferred aspect of the methods of treatment, the formulation is applied in a band along the lower portion of the back of the mammal.

Preferably, so as to maximise efficiency of delivery of the active agents to the bloodstream of the animal, the formulation is applied to the animal over as small a region as possible while avoiding run-off of the formulation, so as to maximise the concentration of active agents per cm² of animal surface.

In another preferred aspect of the methods of treatment, the formulation is sprayed onto the back of the animal.

Where the animals to be treated are cattle, the formulation is preferably applied to the flat part of the back, typically the last third of the animal, and most typically starting from the thoracic vertebrae and proceeding towards the rump of the animal. Typically, about 24 mg benzimidazole/salicylanilide and about 1.5 mg macrocyclic lactone are applied per kilogram of animal. Typically, the band of formulation applied will be from about 5 cm to about 15 cm wide and, depending on the size of animal, about 20 cm-to 40 cm long, and even more typically, the formulation is sprayed onto the back of the animal and the height of the source of spray relative to the back of the animal is maintained at about 5 cm to 10 cm.

As used herein, the term “treating or preventing”, refers to any and all uses which remedy or prevent a diseased or infested state or symptoms, or otherwise prevent, hinder, retard, or reverse the progression of disease/infestation or other undesirable symptoms in any way whatsoever. “Infestation” and corresponding derived terms relate to infestation by endo- and/or ecto-parasites.

An “effective amount”, as referred to herein, includes a non-toxic therapeutic or prophylactic amount of an active agent adequate to provide the desired effect. The “effective amount” will vary from subject-to-subject, depending on one or more of a number of factors amongst, for example, the particular agent being administered, the type and/or severity of a condition being treated, the species being treated, the weight, age and general condition of the subject and the mode of administration. For any given case, an appropriate “effective amount” may be determined by one of ordinary skill in the art using only routine experimentation. Also, extensive literature is available for many known active agents through, for example, manufacturers' catalogues, the Internet, scientific journals and patent literature, including effective amounts for administration to target animals.

Typically, “effective amount” refers to an amount of active agent sufficient to result in one or more or the following: recession/reduction in the extent of a disease/infestation; inhibition of disease/infestation growth or progression; cessation of disease/infestation growth or progression; prevention of disease/infestation; relief of disease/infestation-imposed discomfort; or prolongation of life of the animal having the disease.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

As used herein, the term “comprising” means “including principally, but not necessarily solely”. Variations of the word “comprising”, such as “comprise” and “comprises”, have correspondingly similar meanings.

### DETAILED DESCRIPTION OF THE INVENTION

Aqueous Micellar Formulations

The present invention is based on the finding that hydrophobic active agents, such as benzimidazoles and salicylanilides, may be provided in a formulation for topical administration along with therapeutic amounts of a macrocyclic lactone for efficient delivery of both the benzimidazole/salicylanilide and the macrocyclic lactone to the bloodstream of the animal for effective control of endoparasites such as liver fluke and nematodes. It has also been found by the present investigations that efficiency of delivery of the active agents to the bloodstream of a mammal is affected by the topical location of application of the formulation, minimising the area of the skin to which the active agents are applied and/or use of formulations having elevated concentrations of the active agents. The formulations of the present invention surprisingly allow for elevated concentrations of benzimidazole(s) or salicylanilide(s), in combination with one or more macrocyclic lactones, to be provided in a single composition for efficient delivery of the active agents to the bloodstream of a mammal by topical administration.

The formulations are aqueous micellar compositions, comprising elevated levels of the active agents and, per litre of formulation:
from about 10 g to 400 g veterinary-acceptable surfactant(s);
from 200 g to 750 g veterinary-acceptable water-miscible solvent(s); and
from 50 g to 350 g water.

Advantageously, the surfactant is non-ionic and selected from sorbitan esters, polyoxyalkylated sorbitan esters, polyoxyalkylated alkyl ethers, polyoxyalkylated fatty alcohols, polyoxyalkylated fatty acids, polyalkylene glycol esters, polyoxyalkylated derivatives of castor oil, polyglycerol esters, copolymers of ethylene oxide and propylene oxide; amine ethoxylates; alkyl phenol ethoxylates; alkyl polysaccharides; or combinations thereof, although the surfactant may also be, or include, anionic surfactants selected from linear alkylbenzene sulphonates; C12-to-C16 alcohol sulphates; C12 alkoxypolyethanoxy sulphates; alkyl phosphates and phosphonates or combinations thereof.

Preferred surfactants are selected from polyoxyalkylated fatty alcohols and polyoxyethylene sorbitan- or sorbitol-fatty acid esters or combinations thereof, and particularly preferred are polyoxyethylene sorbitan- or sorbitol-fatty acid esters.

Generally, the polyoxyalkylene sorbitan- or sorbitol-fatty acid esters are polyoxyethylene sorbitan fatty acid esters. Polyoxyethylene sorbitan fatty acid esters such as those of the Ecoteric® series (Huntsman) are preferred. Especially preferred polyoxyethylene sorbitan fatty acid ester surfactants are polyoxyethylene (20) sorbitan monolaurate (Ecoteric® T 20) and polyoxyethylene (20) sorbitan monooleate (Ecoteric® T 80).

Typically the polyoxylated fatty alcohols are polyalkylene oxide derivatives of natural or synthetic alcohols, and those of synthetic alcohols, such as provided by the Teric® series (Huntsman) are preferred. Especially preferred is Teric® BL8.

Generally, the amount of surfactant used in the formulation ranges from about 100 g/L to about 400 g/L, typically about 100 g/L to about 300 g/L, more typically about 150 g/L to about 300 g/L, even more typically about 150 g/L to about 250 g surfactant, and even more typically about 175 g/L to about 225 g/L, preferably about 200 g/L, based on the total amount of formulation.

The water-miscible solvent(s) may be selected from: ethanol; isopropanol; benzyl alcohol; glycol ethers; liquid polyoxyethylene glycols; or a mixture of at least two of these solvents.

Particularly-preferred water-miscible solvents are the glycol ethers, and particularly in combination with a liquid polyethylene glycol. A particularly-preferred polyethylene glycol is PEG 200.

Generally, the glycol ethers are alkylene glycol alkyl ethers, including ethylene glycol monoethyl ether, ethylene glycol monomethyl ether, propylene glycol monomethyl ether (Glysolv PM®, Huntsman), dipropylene glycol monomethyl ether, diethylene glycol monoethyl ether (Ethyl di Glysolv®, Huntsman), diethylene glycol monobutyl ether (Butyl di Glysolv® or Butyl Digol®, Huntsman), and diethylene glycol diethyl ether and the like. Particularly preferred glycol ethers are diethylene glycol monoethyl ether (Ethyl di Glysolv®) and/or diethylene glycol monobutyl ether (Butyl di Glysolv® or Butyl Digol®).

Generally, the amount of water-miscible solvent(s) used in the formulation ranges from about 200 g/L to about 750 g/L, typically about 300 g/L to about 650 g/L, more typically about 300 g/L to about 550 g/L and even more typically about 400 g/L to about 550 g/L, preferably about 450 g/L to about 550 g/L, based on the total amount of formulation, but will vary depending on the particular solvent(s) used and the amount of active agents to be included in the micellar formulation.

Where, according to a preferred aspect of the invention, the formulation comprises both a glycol ether and a liquid polyethylene glycol, the amount of glycol ether used in the formulation typically ranges from about 350 g/L to about 650 g/L, more typically about 400 g/L to about 600 g/L and even more typically about 450 g/L to about 550 g/L, preferably about 450 g/L to about 500 g/L, based on the total amount of formulation. The amount of liquid polyethylene glycol used in the formulation typically ranges from about 10 g/L to about 100 g/L, more typically from about 20 g/L to about 70 g/L, even more typically from about 20 g/L to about 50 g/L, preferably about 30 g/L, based on the total amount of formulation.

Generally, the amount of water used in the formulation ranges from about 50 g/L to about 350 g/L, typically about 100 g/L to about 300 g/L, more typically about 100 g/L to about 250 g/L, and even more typically about 150 g/L to about 200 g/L, preferably about 150 g/L, based on the total amount of formulation.

Examples of suitable benzimidazoles include: 2-(4-thiazolyl)-1H-benzimidazole, known as thiabendazole; [5-(propylthio)-1H-benzimidazol-2-yl]carbamic acid methyl ester, known as albendazole; [5-(propylsulfinyl)-1H-benzimidazol-2-yl]carbamic acid methyl ester known as albendazole sulfoxide or albendazole oxide; [2-(4-thiazolyl)-1H-benzimidazol-5-yl]carbamic acid 1-methylethyl ester, known as cambendazole; [5-(phenylthio)-1H-benzimidazol-2-yl]carbamic acid methyl ester, known as fenbendazole; (5-benzoyl-1H-benzimidazol-2-yl)carbamic acid methyl ester, known as mebendazole; [5-(phenylsulfinyl)-1H-benzimidazol-2-yl]carbamic acid methyl ester, known as is oxfendazole; (5-propoxy-1H-benzimidazol-2-yl)carbamic acid methyl ester, known as oxibendazole; [5-(N-butyl)-1H-benzimidazol-2-yl]carbamic acid methyl ester known as parbendazole; methyl 5-cyclopropylcarbonyl-1H-benzimidazol-2-ylcarbamate known as cyclobendazole; methyl 5-(4-fluorobenzoyl)-1H-benzimidazol-2-ylcarbamate known as flubendazole; 5-chloro-6-(2,3-dichlorophenoxy)-2-(methylthio)-benzimidazole known as triclabendazole; and [5-(4-fluoro-phenylsulfonyloxy)-1H-benzimidazol-2-yl]carbamic acid methyl ester known as luxabendazole.

The benzimidazole antiparasitic agents are active against one or more of Haemonchus, Ostertagia, Trichostrongylus, Nematodirus, Cooperia, Bunostomum, Strongyloides, Trichuris, Oesophagostomum, Chabertia, Dictyocaulus, Moniezia and Fasciola in sheep and against Haemonchus, Ostertagia, Trichostrongylus, Nematodirus, Cooperia, Bunostomum, Capillaria, Strongyloides, Trichuris, Oesophagostomum, Chabertia, Dictyocaulus, Moniezia and Fasciola in cattle.

Particularly preferred as benzimidazole is triclabendazole.

Examples of suitable salicylanilide compounds for use in the control of Fasciola and Haemonchus species in livestock include oxyclozanide (3,3′,5,5′,6-pentachloro-2′-hydroxysalicylanilide), closantel (5′-chloro-4′-(4-chloro-alpha-cyanobenzyl)-3,5-diiodosalicyl-o-toluidide), rafoxanide (3′-chloro-4′-(4-chlorophenoxy)-3,5-diiodosalicylanilide), and niclosamide (2′,5-dichloro-4′-nitrosalicylanilide), as well as clioxanide, brotianide and bromoxanide.

Salicylanilide derivatives, and their use for control of endoparasites in livestock, has been described in, for example, U.S. Pat. Nos. 3,914,418; 3,927,071; 3,989,826; 4,005,218; and 4,025,647, “Veterinary Anthelmintics”, by J. H. Arundel, University of Sydney, Post Graduate Foundation in Veterinary Science, and the Merck Veterinary Manual (http://www.merckvetmanual.com/mvm/index.jsp?cfile=htm/bc/191415.htm).

Oxyclozanide is a particularly preferred salicylanilide for use in formulations according to the invention.

Typically, the macrocyclic lactone(s) is/are selected from the group consisting of ivermectin (22,23-dihydroavermectin B₁ described in EP 295117), abamectin, avermectin A₁ₐ, avermectin A_{1b}, avermectin A₂ₐ, avermectin A_{2b}, avermectin B₁ₐ, avermectin B_{1b}, avermectin B₂ₐ, and avermectin B_{2b}. Also typically, the macrocyclic lactone may be selected from active derivatives of the naturally occurring avermectins, such as derivatives which have a group at the 25-substituent other than the isopropyl or (S)-sec-butyl groups, as set out in European patent applications 0214731, 0284176, 0308145, 0317148, 0335541 and 0340832. Also, typically, the macrocyclic lactone of the first aspect of the invention can include moxidectin (and derivatives disclosed in European patent publication No. 259779A), doramectin and its analogues (described in European patent publication No. 0214731B), selamectin, eprinomectin, milbemycin including milbemycin oxime, milbemycin D (Antibiotic B41D) and its analogues (described in U.S. Pat. No. 3,950,360) and nemadectins (described in European patent publication No. 170006A).

The macrocyclic lactone antiparasitic agents are active against one or more of Haemonchus, Ostertagia, Trichostrongylus, Nematodirus, Cooperia, Strongyloides, Trichuris, Oesophagostomum, Chabertia and Dictyocaulus in sheep and against Haemonchus, Ostertagia, Trichostrongylus, Nematodirus, Cooperia, Oesophagostomum and Dictyocaulus in cattle.

Particularly preferred as a macrocyclic lactone is ivermectin.

Generally, where present, the amount of benzimidazole used in the formulation ranges from about 90 g/L to about 360 g/L, typically about 90 g/L to about 300 g/L, more typically about 150 g/L to about 300 g/L, even more typically about 180 g/L to about 270 g/L, and even more typically about 180 g/L to about 240 g/L, preferably about 240 g/L, based on the total amount of formulation. Generally about 9 mg to about 36 mg, typically about 9 mg to about 30 mg, more typically about 15 mg to about 30 mg, even more typically about 18 mg to about 27 mg, and even more typically 18 mg to about 24 mg, preferably about 24 mg of benzimidazole per kg bodyweight are applied topically to a mammal in a single dosage.

Generally, where present, the amount of salicylanilide used in the formulation ranges from about 125 g/L to about 500 g/L, typically about 160 g/L to about 375 g/L, more typically about 200 g/L to about 350 g/L, even more typically about 250 g/L to about 350 g/L, and even more typically about 300 g/L to about 330 g/L, preferably about 330 g/L based on the total amount of formulation. Generally, about 12.5 mg to about 50 mg of oxyclozanide, typically about 16 mg to about 37.5 mg, more typically about 20 mg to about 35 mg, even more typically about 25 mg to about 35 mg, and even more typically about 30 mg to about 35 mg, preferably about 33 mg of salicylanilide per kg bodyweight is applied topically to a mammal in a single dosage.

Generally the amount of macrocyclic lactone used in the formulation ranges from about 2.5 g/L to about 25 g/L, typically about 4 g/L to about 20 g/L, more typically about 7.5 g/L to about 20 g/L and even more typically about 7.5 g/L to about 15 g/L, preferably about 15 g/L, based on the total amount of formulation. Generally about 0.25 mg to about 2.5 mg, typically about 0.4 to about 2.0 mg, more typically about 0.75 mg to about 2.0 mg, even more typically about 0.75 mg to about 1.5 mg, preferably about 1.5 mg of macrocyclic lactone per kg bodyweight are applied topically to a mammal in a single dosage.

Advantageously, the aqueous micellar formulations according to the invention also comprise a stabilizer. Preferably the stabilizer is selected from anionic surfactants such as linear alkyl sulphates (for example, sodium dodecyl sulphate), linear alkyl benzene sulphonates (such as calcium dodecyl benzene sulphonate) and buffering agents, typically selected from soluble monobasic and/or dibasic phosphates.

Sodium dodecyl sulphate is typically used as a stabilizer in the formulation in the range of from about 10 g/L to about 30 g/L, more typically from about 10 g/L to about 20 g/L, based on the total amount of formulation; phosphates are typically used in the formulation in the range of from about 1 g/L to about 10 g/L, more typically from about 1 g/L to about 5 g/L, and more typically from about 1 g/L to 2 g/L, based on the total amount of formulation.

The aqueous micellar formulations may also include one or more further veterinary excipients, provided these do not destabilise the micellar formulation.

Veterinary acceptable excipients for use in preparing the formulations may include, for example: further solvents such as, for example, water immiscible solvents including glycol ether esters; viscosity modifiers/suspending agents, for example, gelatin, vegetable gums such as xanthan gum, cellulose derivatives (e.g. microcrystalline cellulose, anionic or non-ionic cellulose ethers, such as carboxymethylcellulose), fumed silica (colloidal silicon dioxide), or polyvinylpyrrolidone polymers, and magnesium aluminium silicates such as VEEGUM® (R. T. Vanderbilt), and mixtures of these.

Examples of suitable veterinary acceptable adjuvants include dyes.

Dyes enable the treated mammals to be distinguished from the untreated. The dyestuff may be dissolved, suspended or dispersed in the carrier. The nature of the colouring agent is unimportant and a wide variety of suitable dyes and pigments will be known to the skilled person. The colouring agent may be soluble or insoluble in water. Generally, however, the dyestuff will be biodegradable so as to fade and not permanently mark the skin or fleece. Some examples of suitable dye agents include: FD&C Brilliant Blue No. 1 (Brilliant Blue FCF, Hexacol Brilliant Blue), and Fast Scarlet Pigment 3610.

Processes for the Preparation of Micellar Formulations of the Invention

The micellar formulations according to the invention may be prepared by methods and techniques known to those of skill in the art.

Typically the formulations may be made using a simple process:

Step 1. Charge 80% of the total volume of water-miscible (non flammable) solvent and the surfactant to a manufacturing vessel. Heat to 40° C.-75° C. (flammable solvents such as ethanol and isopropanol, whether added as major water-miscible solvent or as a minor component should be used at ambient temperature).

Step 2. Add the benzimidazole or salicylanilide incrementally with continued stirring and heating until dissolved.

Step 3. Add sequentially the water, and optionally stabilizers and dye, stirring until dissolved.

Step 4. Cool to room temperature with continued stirring.

Step 5. Add the macrocyclic lactone incrementally with stirring until dissolved (also, if flammable solvents such as ethanol or isopropanol are to be added as co-solvents, they should be added here).

Step 6. Add the remaining solvent to volume.

Methods of Treatment and/or Prevention of Diseases or Infestations

The formulations according to the invention may be used for the treatment and/or prevention of diseases or infestations by endoparasites in mammals, typically in livestock such as sheep or cattle, by applying the formulation(s) to the back of the mammal. Important diseases/infestations which may be controlled include liver fluke, nematodes and lice in sheep and cattle and buffalo fly and ticks on cattle.

It was found that optimal uptake of the active agents into the bloodstream of treated mammals occurred when the formulations were applied to a region starting from the flat part of an animals back—approximately at the location of the thoracic vertebrae—and working towards the rump of the animal, effectively resulting in application of the formulation to the last third of the mammal's back. This mode of application was found to be significantly more effective than application starting at the neck.

Efficiency of delivery of the active agents to the bloodstream of a mammal was also found to be greatest where the surface area to which the formulation is applied was minimised, while avoiding run-off of the formulation, so as to maximise the concentration of active agents per cm² of animal surface, typically covering an area of about 100 cm² to about 400 cm² for cattle and about 100 cm² for sheep.

Typically the formulation is applied by spray onto the mammal's back, preferably from a constant height relative to the mammal's back.

For cattle, the band of formulation is typically applied starting from the thoracic vertebrae and proceeding towards the rump of the animal. Typically, from about 18 mg to about 24 mg benzimidazole and from about 0.75 mg to about 2.0 mg macrocyclic lactone are applied per kilogram animal. More typically, where triclabendazole and ivermectin are the active agents comprised in the formulation from about 18 mg to about 24 mg, preferably about 24 mg triclabendazole and from about 0.75 mg to about 2.0 mg, preferably about 1.5 mg ivermectin are applied per kilogram of animal. Preferably this amount of active agents is applied to the mammal in about 0.05 mL to about 0.1 mL per kg animal, and in a band from about 5 cm to about 15 cm wide. In weaned calves typically weighing from about 100 cm to about 180 kg per head, good results were obtained by spraying about 10 mL to about 18 mL formulation onto the backs of the animals, starting from the thoracic vertebrae and working towards the animals' rumps, from a constant height of about 15 cm relative the backs of the animals, resulting in an applied band of formulation about 10 cm to about 15 cm wide and about 20 cm long.

Preferred forms of the present invention will now be described, by way of example only, with reference to the following examples, including comparative data, and which are not to be taken to be limiting to the scope or spirit of the invention in any way.

### EXAMPLES

### Example 1

### Aqueous Micellar Formulations, and Processes for Preparing Them

| | |
|---|---|
| Component | g/L |

1.1 Formulation A

| | | |
|---|---|---|
| Triclabendazole | 240 | |
| Ivermectin | 7.5 | |
| Polyoxyethylene (20) sorbitan monolaurate (Ecoteric ® T 20) | 200 | |
| Polyethylene glycol 200 (PEG 200) | 30 | |
| Water | 150 | |
| Sodium dodecyl sulphate | 20 | |
| Brilliant Blue FCF | 0.16 | |
| Diethylene glycol monobutyl ether | to 1 | L |

1.2 Formulation B

| | | |
|---|---|---|
| Triclabendazole | 240 | |
| Ivermectin | 7.5 | |
| Polyoxyethylene (20) sorbitan monolaurate (Ecoteric ® T 20) | 200 | |
| Polyethylene glycol 200 (PEG 200) | 30 | |
| Water | 250 | |
| Sodium dodecyl sulphate | 20 | |
| Brilliant Blue FCF | 0.16 | |
| Diethylene glycol monobutyl ether | to 1 | L |

1.3 Formulation C

| | | |
|---|---|---|
| Triclabendazole | 120 | |
| Ivermectin | 5.0 | |
| Polyalkylene oxide derivative of synthetic alcohol | 200 | |
| (Teric ® BL8) | | |
| Benzyl alcohol | 30 | |
| Water | 150 | |
| Dihydrogen sodium phosphate | 7.84 | |
| Disodium hydrogen phosphate | 0.91 | |
| Brilliant Blue FCF | 0.16 | |
| Diethylene glycol monobutyl ether | to 1 | L |

1.4 Formulation D

| | | |
|---|---|---|
| Triclabendazole | 120 | |
| Ivermectin | 5.0 | |
| Polyoxyethylene (20) sorbitan monooleate (Ecoteric ® T 80) | 200 | |
| Benzyl alcohol | 30 | |
| Water | 250 | |
| Disodium hydrogen phosphate | 0.91 | |
| Dihydrogen sodium phosphate | 7.84 | |
| Brilliant Blue FCF | 0.16 | |
| Propylene glycol monomethyl ether (Glysolv PM ®) | to 1 | L |

1.5 Formulation E

| | | |
|---|---|---|
| Oxyclozanide | 350 | |
| Ivermectin | 7.5 | |
| Polyoxyethylene (20) sorbitan monooleate (Ecoteric ® T 80) | 200 | |
| Water | 150 | |
| Sodium dodecyl sulphate | 20 | |
| Brilliant Blue FCF | 0.16 | |
| Diethylene glycol monobutyl ether | to 1 | L |

1.6 Formulation F

| | | |
|---|---|---|
| Triclabendazole | 240 | |
| Ivermectin | 10.0 | |
| Polyoxyethylene (20) sorbitan monolaurate (Ecoteric T 20) | 200 | |
| Polyethylene glycol 200 (PEG 200) | 30 | |
| Water | 150 | |
| Sodium dodecyl sulphate | 20 | |
| Brilliant Blue FCF | 0.16 | |
| Diethylene glycol monobutyl ether | to 1 | L |

1.7 Formulation G

| | | |
|---|---|---|
| Triclabendazole | 240 | |
| Ivermectin | 15.0 | |
| Polyoxyethylene (20) sorbitan monolaurate (Ecoteric T 20) | 200 | |
| Polyethylene glycol 200 (PEG 200) | 30 | |
| Water | 150 | |
| Sodium dodecyl sulphate | 20 | |
| Brilliant Blue FCF | 0.16 | |
| Diethylene glycol monobutyl ether | to 1 | L |

Other stable aqueous micellar formulations according to the invention are described in Examples 2 and 3.

The formulations were prepared by the following procedure:

Step 1. Charge 80% of the total volume of water-miscible solvent and the surfactant to a manufacturing vessel. Heat to 40-75° C. with stirring.

Step 2. Add the benzimidazole or salicylanilide incrementally with continued stirring and heating until dissolved.

Step 3. Add sequentially the water, and optionally stabilizers and dye, stirring until dissolved.

Step 4. Cool to room temperature with continued stirring.

Step 5. Add the macrocyclic lactone incrementally with stirring until dissolved.

Step 6. Add the remaining solvent to volume.

### Example 2

### Pharmacokinetic Studies

Materials and Methods

Formulations according to the invention were tested for their efficacy in delivering benzimidazoles and macrocyclic lactones to the bloodstream of mammals (cattle), and compared to the efficacy in delivering these agents to animals' bloodstreams by standard commercially available drench (Fasinex 120®), and an experimental solvent-based triclabendazole/ivermectin pour-on formulation.

Cattle (typically Hereford or Hereford cross) with either natural or artificially infected burdens of fluke and nematodes were used in pen and field trials. Within a given trial animals were allotted into treatment groups, each having similar mean weights and fluke and nematode burdens. Experimental treatments were applied along the backline using a commercially available backliner gun fitted with a plastic shroud to ensure correct delivery of the formulation according to the protocol.

Blood samples (plasma) were taken by venipuncture of the jugular vein at the designated time intervals. Analysis for triclabendazole and ivermectin residues in the plasma was carried out and reported by commercial contract laboratories.

Ivermectin was extracted from the plasma using acetonitrile and concentrated by evaporation. The sample was cleaned up by solid phase extraction (SPE) chromatography and the ivermectin determined as the N-methyl imidazole derivative using reverse phase HPLC with fluorescence detection.

The triclabendazole was extracted from the plasma using ethyl acetate. Following concentration and SPE clean up, the triclabendazole and its sulphone and sulphoxide metabolites were analysed by reverse phase HPLC using UV detection.

Results

Initial feasibility studies for development of an efficient flukicide product were based on the pharmacokinetic profile of triclabendazole only. Although noting that the bioavailability of the active agents is always delayed after application as a pour-on formulation compared to a drench treatment, blood plasma levels for the experimental formulations were targeted at the maximum triclabendazole plasma levels (Cₘₐₓ) produced by the currently available flukicide, Fasinex® 120 (triclabendazole Cₘₐₓ 16.5 μg/mL after 2 days), when applied at a rate of 12 mg/kg bodyweight.

Having reference to Table 1, the following results were obtained.

In a first feasibility trial (Hereford male weaner cattle, average weight of approximately 200 kg, 2 animals per group), a solvent-based formulation (N-methylpyrrolidone/Butyl diGlysolv®, Formulation 1), triclabendazole was applied at 50 mg/kg to achieve similar plasma levels as per the currently available flukicide, Fasinex® 120 (15.7 μg/mL after 7 days). Such a dose rate is not commercially viable.

In a second feasibility trial (Hereford male and female weaner cattle, average weight of approximately 160 kg, 3 animals per group) the triclabendazole dose rate was reduced to a more commercially acceptable level (12 mg/kg). A surfactant (Teric® BL8) was added to Formulation 1 to improve the formulation's hide wettability to produce Formulation 2 (non aqueous micelle), and N-methyl pyrrolidine solvent was removed. Triclabendazole Cₘₐₓ (total metabolite) plasma levels achieved were low (2.0 μg/mL).

Addition of 15% water to Formulation 1 produced Formulation 3 (Formulation C described in Example 1.3 above, an aqueous micelle), and this increased the triclabendazole Cₘₐₓ achieved to 4.8 μg/mL.

TABLE 1

| Formulation | | g or mL | | Dose Rate | | | Tₘₐₓ |
|---|---|---|---|---|---|---|---|
| and Type | Formulation Details | per litre | | mg/kg | Plasma Cₘₐₓ | | days |
| 1 | Triclabendazole | 250 | g | 50 | 15.7 | μg/mL | 7 |
| | Ivermectin | 2.5 | g | | | | |
| Solvent based | N-Methyl | 400 | mL | | | | |
| | pyrrolidone | | | | | | |
| | Butyl di Glysolv ® | 575 | mL | | | | |
| Control Fasinex | 120 g/L TCBZ | | | 12 | 16.5 | μg/mL | 2 |
| 120 | | | | | | | |
| 2 | Triclabendazole | 120 | g | 12 | 2.0 | μg/mL | 7 |
| | Ivermectin | 5.0 | g | | | | |
| Non-aqueous | Teric ® BL8 | 200 | g | | | | |
| micelle | Benzyl alcohol | 30 | g | | | | |
| | Butyl di Glysolv ® | 650 | mL | | | | |
| 3 | Triclabendazole | 120 | g | 12 | 4.8 | μg/mL | 7 |
| | Ivermectin | 5.0 | g | | | | |
| Aqueous | Teric ® BL8 | 200 | g | | | | |
| micelle | Water | 150 | g | | | | |
| | Benzyl alcohol | 30 | g | | | | |
| | Butyl di Glysolv ® | 520 | mL | | | | |
| 4 | Triclabendazole | 120 | g | 12 | 8.7 | μg/mL | 7 |
| | Ivermectin | 5.0 | g | 0.5 | 1.3 | ng/mL | 5 |
| Aqueous | Teric ® BL8 | 200 | g | | | | |
| micelle | Water | 250 | g | | | | |
| | Benzyl alcohol | 30 | g | | | | |
| | Glysolv PM ® | 420 | mL | | | | |
| | Dihydrogen Sodium | 7.84 | g | | | | |
| | Phosphate | | | | | | |
| | Disodium Hydrogen | 0.91 | g | | | | |
| | phosphate | | | | | | |
| 5 | Triclabendazole | 120 | g | 12 | 8.7 | μg/mL | 7 |
| | Ivermectin | 5.0 | g | 0.5 | 2.6 | ng/mL | 2 |
| Aqueous | Teric ® BL8 | 200 | g | | | | |
| micelle | Water | 150 | g | | | | |
| | Benzyl alcohol | 30 | g | | | | |
| | Glysolv PM ® | 520 | mL | | | | |
| | Dihydrogen sodium | 7.84 | g | | | | |
| | Phosphate | | | | | | |
| | Disodium hydrogen | 0.91 | g | | | | |
| | phosphate | | | | | | |
| 6 | Triclabendazole | 120 | g | 12 | 15.9 | μg/mL | 7 |
| | Ivermectin | 5.0 | g | 0.5 | 2.8 | ng/mL | 5 |
| Aqueous | Ecoteric ® T20 | 200 | g | | | | |
| micelle | Water | 250 | g | | | | |
| | Benzyl alcohol | 30 | g | | | | |
| | Glysolv PM ® | 420 | mL | | | | |
| | Dihydrogen Sodium | 7.84 | g | | | | |
| | Phosphate | | | | | | |
| | Disodium Hydrogen | 0.91 | g | | | | |
| | phosphate | | | | | | |
| 7 | Triclabendazole | 120 | g | 12 | 12.9 | μg/mL | 7 |
| | Ivermectin | 5.0 | g | 0.5 | 3.0 | ng/mL | 7 |
| Aqueous | Ecoteric ® T80 | 200 | g | | | | |
| micelle | Water | 250 | g | | | | |
| | Benzyl alcohol | 30 | g | | | | |
| | Glysolv PM ® | 420 | mL | | | | |
| | Dihydrogen Sodium | 7.84 | g | | | | |
| | Phosphate | | | | | | |
| | Disodium Hydrogen | 0.91 | g | | | | |
| | phosphate | | | | | | |

In a further feasibility trial (Hereford female cattle, average weight of approximately 235 kg, 3 animals per group), the water content in the formulation was increased to 25% and Butyl di Glysolv® was replaced with Glysolv PM®. The resulting Formulation 4, provided an increased triclabendazole Cₘₐₓ Of 8.7 μg/mL—almost double that achieved with Formulation 3. The ivermectin Cₘₐₓ achieved was 1.3 ng/mL at 5 days.

A similar formulation, Formulation 5, had a water content of 15%. Although the Cₘₐₓ for triclabendazole was almost the same, 8.6 μg/mL, the Cₘₐₓ for ivermectin was 2.6 ng/mL at 2 days.

Replacing Teric® BL8 in Formulation 4 with Ecoteric® T20 resulted in Formulation 6 (with a water content of 25%)—this formulation achieved substantially the same plasma levels as Fasine® 120 drench (triclabendazole Cₘₐₓ of 15.9 μg/mL versus 16.5 μg/mL) applied at the equivalent dose rate of 12 mg/kg. The C max achieved for ivermectin was 2.8 ng/mL at 5 days.

Formulation 7 again showed increased bioavailability of triclabendazole when Teric® BL8 was replaced with Ecoteric® T80. The Cₘₐₓ achieved for triclabendazole was 12.9 μg/mL and the Cₘₐₓ achieved for ivermectin was 3.0 ng/mL at 2 days.

Having reference to Table 2, in a further feasibility trial (Hereford female weaner cattle, average weight of approximately 200 kg, 3 animals per group) reduction of the water content of the formulations to 150 g/L, and reverting to Ecoteric° T20 in place of Ecoteric® T80, increased the efficiency of delivery of ivermectin, the ivermectin plasma Cₘₐₓ values for the formulations ranging from 8 ng/mL to 13 ng/mL.

TABLE 2

| Formulation | g or mL | | Dose Rate | | | Mean | | Plasma | | Tₘₐₓ |
|---|---|---|---|---|---|---|---|---|---|---|
| Components | per litre | | mg/kg | AUC | | plasma | | Cₘₐₓ | | days |
| Triclabendazole | 90 | g | 9.0 | 72 | μg · d/mL | 3.6 | μg/mL | 9 | μg/mL | 5 |
| Ivermectin | 10.0 | g | 1.0 | 88 | ng · d/mL | 4.4 | ng/mL | 8 | ng/mL | 5 |
| Ecoteric ® T20 | 200 | g | | | | | | | | |
| Water | 150 | g | | | | | | | | |
| Benzyl alcohol | 30 | g | | | | | | | | |
| Triethanolamine | 5.0 | g | | | | | | | | |
| Glysolv PM ® | 608 | mL | | | | | | | | |
| Triclabendazole | 120 | g | 12 | 85 | μg · d/mL | 4.1 | μg/mL | 12 | μg/mL | 5 |
| Ivermectin | 5.0 | g | 0.5 | 52 | ng · d/mL | 2.5 | ng/mL | 8 | ng/mL | 5 |
| 7Ecoteric ® T20 | 200 | g | | | | | | | | |
| Water | 150 | g | | | | | | | | |
| Benzyl alcohol | 30 | g | | | | | | | | |
| Triethanolamine | 5.0 | g | | | | | | | | |
| Glysolv PM ® | 588 | mL | | | | | | | | |
| Triclabendazole | 180 | g | 18 | 139 | μg · d/mL | 6.8 | μg/mL | 18 | μg/mL | 5 |
| Ivermectin | 7.5 | g | 0.75 | 79 | ng · d/mL | 4.1 | ng/mL | 13 | ng/mL | 5 |
| Ecoteric ® T20 | 200 | g | | | | | | | | |
| Water | 150 | g | | | | | | | | |
| Benzyl alcohol | 30 | g | | | | | | | | |
| Triethanolamine | 5.0 | g | | | | | | | | |
| Glysolv PM ® | 553 | mL | | | | | | | | |

From the results provided in Tables 1 and 2, it is apparent that the pharmacokinetics of the active agents can be altered as desired by manipulating the water content, and the type and content of the surfactant and/or the co-solvent used in micellar formulations according to the invention.

Manipulation of the solvent and co-solvent type has also been found during the course of these experiments to affect the physical stability of the micellar formulations, use of a combination of Butyl diGlysolv® and PEG 200 providing the best cold storage stability and highest maximum concentration for triclabendazole of the formulations tested, thereby providing a more rugged product suitable for application to animals in the cooler months of late autumn or early spring—although there is no published data, it has been reported that greater amounts of active components need to be applied to animals in colder months to get the required efficacy, and these months are typically the most important in liver fluke control.

### Example 3

### Dosing Studies

### Example 3.1

### Concentration Effect (Constant Volume)

Having reference to Table 2, it can be seen that altering the concentration of triclabendazole and/or ivermectin in the aqueous micellar formulations of the invention provides a corresponding change in AUC, when applied to the animal in the same volume of formulation (1 mL applied/10 kg animal).

### Example 3.2

### Concentration Effect (Constant Dose)

Having reference to Table 3, in a critical slaughter efficacy trial of formulations according to the invention (methods as per Example 2; mixed sex Hereford weaner cattle, average weight of approximately 200 kg, 5 animals per group), an aqueous micellar formulation according to the invention comprising triclabendazole at 240 g/L, but varying ivermectin concentration was applied at a constant ivermectin dosage rate (0.5 mg/kg), but varying triclabendazole dosage rate (12 to 36 mg/kg).

The results show that application of a more concentrated ivermectin dose in a smaller volume (same final ivermectin dose rate), resulted in improved pharmacokinetic results, including greater Cₘₐₓ and/or greater bioavailability (AUC) of the ivermectin.

TABLE 3

| | | | Dose | Dose | | | | | | |
|---|---|---|---|---|---|---|---|---|---|---|
| Formulation | g or mL | | Rate | Rate | | | | Plasma | | Tₘₐₓ |
| Components | per litre | | mg/kg | mL/kg | | AUC | | Cₘₐₓ | | days |
| Triclabendazole | 240 | g | 12 | 1 | ml/20 | 73 | μg · d/mL | 8.3 | μg/mL | 5 |
| Ivermectin | 10 | g | 0.5 | 1 | ml/20 | 104 | ng · d/mL | 10.4 | ng/mL | 7 |
| Ecoteric ® T20 | 200 | g | | | | | | | | |
| PEG 200 | 30 | g | | | | | | | | |
| Water | 150 | g | | | | | | | | |
| Triethanolamine | 0.74 | g | | | | | | | | |
| Brilliant Blue FCF | 0.16 | g | | | | | | | | |
| Butyl di Glysolv ® | 491 | mL | | | | | | | | |
| Triclabendazole | 240 | | 24 | 1 | ml/10 | 129 | μg · d/mL | 15.1 | μg/mL | 5 |
| Ivermectin | 5 | | 0.5 | 1 | ml/10 | 84 | ng · d/mL | 9.5 | ng/mL | 5 |
| Ecoteric ® T20 | 200 | | | | | | | | | |
| PEG 200 | 30 | | | | | | | | | |
| Water | 150 | | | | | | | | | |
| Sodium dodecyl sulphate | 20 | | | | | | | | | |
| Brilliant Blue FCF | 0.16 | | | | | | | | | |
| Butyl di Glysolv ® | 480 | mL | | | | | | | | |
| Triclabendazole | 240 | g | 36 | 1 | ml/6.67 | 177 | μg · d/mL | 18.6 | μg/mL | 7 |
| Ivermectin | 3.33 | g | 0.5 | 1 | ml/6.67 | 82 | ng · d/mL | 7.5 | ng/mL | 7 |
| Ecoteric ® T20 | 200 | g | | | | | | | | |
| PEG 200 | 30 | g | | | | | | | | |
| Water | 150 | g | | | | | | | | |
| Triethanolamine | 1.12 | g | | | | | | | | |
| Brilliant Blue FCF | 0.16 | g | | | | | | | | |
| Butyl di Glysolv ® | 498 | mL | | | | | | | | |

In another trial (also carried out as described in Example 2), a formulation according to the invention having 180 g/L triclabendazole and 7.5 g/L ivermectin, and a formulation having 240 g/L triclabendazole and 10 g/L ivermectin, were applied to animals over different area sizes on the backs of the animals (from the middle of the back towards the rump), while maintaining the same dose rate for the active constituents. The results, shown in Table 4, show that application of the ivermectin and triclabendazole in a higher concentration formulation applied over a smaller area makes the active agents more bioavailable.

TABLE 4

| | | | | Mean | Mean | | | |
|---|---|---|---|---|---|---|---|---|
| Formulation | g or mL | | Dose rate | Treatment | plasma | | | |
| details | per litre | | (mg/kg) | Area (cm²) | concⁿ | | AUC | |
| Triclabendazole | 180 | | 12.0 | 110 | 3.3 | μg/mL | 65 | μg · d/mL |
| Ivermectin | 7.5 | | 0.5 | | 1.7 | ng/mL | 30 | ng · d/mL |
| Ecoteric T 20 ® | 200 | | (1 mL/15 kg) | | | | | |
| PEG 200 | 30 | | | | | | | |
| Water | 150 | | | | | | | |
| Triethanolamine | 0.15 | | | | | | | |
| Brilliant Blue | 0.16 | | | | | | | |
| FCF | | | | | | | | |
| Butyl diGlysolv ® | 536 | mL | | | | | | |
| Triclabendazole | 240 | | 12.0 | 76 | 5.1 | μg/mL | 170 | μg · d/mL |
| Ivermectin | 10.0 | | 0.5 | | 2.2 | ng/mL | 43 | ng · d/mL |
| | | | (1 mL/20 kg) | | | | | |
| Ecoteric T 20 ® | 200 | | | | | | | |
| PEG 200 | 30 | | | | | | | |
| Water | 150 | | | | | | | |
| Triethanolamine | 0.3 | | | | | | | |
| Brilliant Blue | 0.16 | | | | | | | |
| FCF | | | | | | | | |
| Butyl diGlysolv ® | 500 | mL | | | | | | |

### Example 4

### Stability Studies

Samples of formulation A, the composition and preparation of which is described in Example 1, which contains sodium dodecyl sulphate, were stored at 4, 30 and 40° C. in 250 mL high density polyethylene bottles sealed with screw caps, sampled at 1, 2, 3, 6 and 12 months, and tested for ivermectin and triclabendazole content. Triclabendazole and ivermectin content of the formulations was determined using validated stability indicating methods based on reversed phase HPLC with UV detection. The results, provided in Table 5, demonstrate the chemical stability of the formulation at accelerated storage conditions—effectively no degradation of the active components occurred even after 6 months storage at 40° C. After 12 months storage at 30° C. there was still no measured degradation of the triclabendazole and ivermectin components. After 12 months at 40° C. there was less than 5% breakdown of the ivermectin component.

TABLE 5

| Storage | Triclabendazole Content (g/L) | | | | | Ivermectin Content (g/L) after | | | | |
|---|---|---|---|---|---|---|---|---|---|---|
| Temp. | after storage time (months): | | | | | storage time (months): | | | | |
| (° C.) | 1 | 2 | 3 | 6 | 12 | 1 | 2 | 3 | 6 | 12 |
| 4° C. | 250 | 248 | 247 | 241 | 247 | 7.55 | 7.53 | 7.84 | 7.53 | 7.44 |
| 30° C. | 247 | 248 | 247 | 240 | 248 | 7.47 | 7.52 | 7.77 | 7.49 | 7.43 |
| 40° C. | 247 | 249 | 241 | 242 | 246 | 7.45 | 7.55 | 7.71 | 7.41 | 7.25 |

Samples of formulation G, the composition and preparation of which is described in Example 1, which contains sodium dodecyl sulphate, were stored at 4, 30 and 40° C. in 250 mL high density polyethylene bottles sealed with screw caps, sampled at 1, 2 and 3 months, and tested for ivermectin and triclabendazole content. Triclabendazole and ivermectin content of the formulations was determined using validated stability indicating methods based on reversed phase HPLC with UV detection. The results, provided in Table 6, demonstrate the chemical stability of the formulation at accelerated storage conditions—effectively no degradation of the active components occurred even after 2 months storage at 30 or 40° C.

TABLE 6

| | Triclabendazole | | | Ivermectin | | |
|---|---|---|---|---|---|---|
| | Content (g/L) | | | Content (g/L) | | |
| Storage | after storage | | | after storage | | |
| Temp. | time (months): | | | time (months): | | |
| (° C.) | 1 | 2 | 3 | 1 | 2 | 3 |
| 4° C. | 243 | 241 | 238 | 14.7 | 14.8 | 14.7 |
| 30° C. | 241 | 239 | 236 | 14.5 | 14.5 | 14.6 |
| 40° C. | 237 | 239 | 237 | 14.5 | 14.5 | 14.5 |

In another stability trial a number of substances were tested for their potential as a stabilizer for the formulations, ivermectin being unstable in inadequately stabilised formulations. The substances were each tested at a concentration of 10.0 g/L, except phosphate buffers, in a formulation otherwise having the following composition (per Litre):

| | | |
|---|---|---|
| Triclabendazole | 120 | g |
| Ivermectin | 5.0 | g |
| Teric BL 8 ® | 200 | g |
| Benzyl alcohol | 30 | g |
| Water | 150 | g |
| Brilliant Blue FCF | 0.16 | g |
| Butyl Di Glysolv ® | approximately 485 | mL (to volume) |

The samples were stored at 50° C. in 250 mL high density polyethylene bottles sealed with screw caps, and sampled at 3 months, and tested for ivermectin and triclabendazole content. Triclabendazole and ivermectin content of the formulations was determined using validated stability indicating methods based on reversed phase HPLC with UV detection. The data, provided in Table 7, illustrate the difficulty of stabilising the ivermectin component of the formulation.

From the stability data it was concluded that inclusion of anionic surfactants such as the linear alkyl sulphate sodium dodecyl sulphate, or buffering agents such as one or more monobasic/dibasic phosphates, or mixtures thereof, in the formulations of the invention significantly improve the stability of the ivermectin component.

TABLE 7

| | | Triclabendazole | | | | |
|---|---|---|---|---|---|---|
| | | Content | | | | |
| | | (g/L) after | | Ivermectin Content (g/L) after | | |
| | | storage time: | | storage time: | | |
| | | | 3 months | | 3 months | % Ivermectin |
| Candidate Stabilizer | g/L | Initial | @ 50° C. | Initial | @ 50° C. | Breakdown |
| — | — | 124.1 | 122.0 | 4.96 | 4.33 | 12.7 |
| Butylated hydroxy toluene (BHT) | 10.0 | 123.8 | 122.5 | 4.92 | 4.36 | 11.4 |
| Epoxidised Resin (ERL 4221) | 10.0 | 123.2 | 123.2 | 4.89 | 3.45 | 29.4 |
| Vitamin E Acetate | 10.0 | 123.1 | 122.2 | 4.87 | 4.36 | 10.5 |
| Triethanolamine | 10.0 | 121.7 | 122.4 | 4.70 | 1.88 | 60.0 |
| Disodium hydrogen phosphate | 0.18 | 110.0 | 109.5 | 4.39 | 4.24 | 3.4 |
| Dihydrogen sodium phosphate | 1.57 | | | | | |

### Example 5

### Efficacy Studies

Materials and Methods

Cattle (typically Hereford or Hereford cross breed) with either natural or artificially infected burdens of fluke and nematodes were used in pen and field trials. They were allotted into treatment groups, each having similar mean weights and fluke and nematode burdens. Experimental treatments were applied along the backline from the middle of the back towards the rump, using a commercially available backliner gun fitted with a plastic shroud to ensure correct delivery of the formulation according to the protocol.

Efficacy was measured by either decrease in faecal egg counts over time or total parasite counts from gastrointestinal tracts and livers recovered after slaughter. The reported data are based on group arithmetic and/or group geometric means.

Efficacy based on faecal worm egg counts were calculated as follows:
% Efficacy=100 [1−(T₂C₁/T₁C₂)]
where T, C, 1 and 2 refer to treated, control, pre-treatment and post treatment mean worm egg counts respectively.

All other Efficacy data were calculated using the formula:
% Efficacy=100(C−T/C)
where T and C refer to treated and control mean total worm counts respectively.

For critical slaughter nematode efficacy studies, the animals were slaughtered at 14 or 21 days post treatment.

For critical slaughter efficacy studies against all stages of the liver fluke (artificially infested), the animals were slaughtered 100 days after treatment.

Results

### Example 5.1

A critical slaughter pen efficacy trial (naturally acquired fluke and nematodes) involved mixed sex Hereford and Hereford/Angus cross weaned calves selected from 2 large commercial herds. The animals were randomly allocated to groups of 5 animals such that each group had a similar mean and range of Fasciola hepatica egg counts and body weights. Prior to treatment, animals were moved to a research feedlot to avoid further infection. At treatment the animals were weighed and treated with formulations of the triclabendazole+ivermectin pour on administered at different dose volumes and active concentrations. One group of animals remained as untreated negative control.

All animals were slaughtered 19 to 21 days post treatment, gastrointestinal tracts and livers recovered, and total worm and fluke numbers determined.

Treatment formulations involving different concentrations of active components and/or different excipients were tested, these formulations being as follows:

| | g or mL/L | | Dosage rate (mg/kg) |
|---|---|---|---|
| Group 1 | | | |
| Triclabendazole | 240 | g | 12 |
| Ivermectin | 10.0 | g | 0.5 |
| Ecoteric T20 ® | 200 | g | |
| PEG 200 | 30 | g | |
| Water | 150 | g | |
| Triethanolamine | 0.74 | g | |
| Brilliant Blue FCF | 0.16 | g | |
| Butyl diGlysolv ® | 491 | mL | |
| Group 2 | | | |
| Triclabendazole | 240 | g | 24 |
| Ivermectin | 5.0 | g | 0.5 |
| Ecoteric T20 ® | 200 | g | |
| PEG 200 | 30 | g | |
| Water | 150 | g | |
| Triethanolamine | 1.27 | g | |
| Brilliant Blue FCF | 0.16 | g | |
| Butyl diGlysolv ® | 494 | mL | |
| Group 3 | | | |
| Triclabendazole | 240 | g | 36 |
| Ivermectin | 3.33 | g | 0.5 |
| Ecoteric T20 ® | 200 | g | |
| PEG 200 | 30 | g | |
| Water | 150 | g | |
| Triethanolamine | 1.12 | g | |
| Brilliant Blue FCF | 0.16 | g | |
| Butyl diGlysolv ® | 498 | mL | |
| Group 4 | | | |
| Triclabendazole | 240 | g | 24 |
| Ivermectin | 5.0 | g | 0.5 |
| Ecoteric T20 ® | 180 | g | |
| PEG 200 | 30 | g | |
| Water | 150 | g | |
| Brilliant Blue FCF | 0.16 | g | |
| Sodium dodecyl sulphate | 20 | g | |
| Butyl diGlysolv ® | 480 | mL | |
| Group 5 | | | |
| Triclabendazole | 240 | g | 24 |
| Ivermectin | 5.0 | g | 0.5 |
| Ecoteric T20 ® | 200 | g | |
| PEG 200 | 30 | g | |
| Water | 150 | g | |
| Brilliant Blue FCF | 0.16 | g | |
| Sodium dodecyl sulphate | 20 | g | |
| Butyl diGlysolv ® | 480 | mL | |
| Group 6 | | | |
| Triclabendazole | 240 | g | 24 |
| Ivermectin | 5.0 | g | 0.5 |
| Ecoteric T20 ® | 200 | g | |
| PEG 200 | 30 | g | |
| Water | 150 | g | |
| Brilliant Blue FCF | 0.16 | g | |
| Sodium dodecyl sulphate | 20 | g | |
| Butyl diGlysolv ® | 316 | mL | |
| Ethylene glycoldiacetate | 155 | mL | |

The results, provided in Table 8, show that effective control of flukes and nematodes is achievable using a practical volume of an aqueous micellar pour-on formulation of the present invention.

The product was 100% effective against adult Fasciola hepatica at dose rates of 12, 24 and 36 mg/kg triclabendazole and effective against nematodes at a dose rate of 0.5 mg/kg ivermectin. In this trial, an effective treatment of animals for endoparasites was achieved using 1 mL/20 kg of a formulation including 240 g/L triclabendazole and 10.0 g/L ivermectin (12 mg/kg triclabendazole and 0.5 mg/kg ivermectin).

TABLE 8
% Treatment efficacy against parasites
(values based on the geometric mean of total worm count are given in brackets
where different to those based on the arithmetic mean)

| | Liver | Abomasum | | |
|---|---|---|---|---|
| Group No. | F. hepatica (adult) | H. contortus (adult) | Ostertagia spp (adult) | T. axei (adult) |
| 1 | 100 | >99.9 | >99.9 | >99.9 |
| 2 | 100 | >99.9 | 98.2 (96.4) | >99.9 |
| 3 | 100 | >99.9 | 95.8 (86.6) | >99.9 |
| 4 | 100 | >99.9 | 89.1 (81.8) | >99.9 |
| 5 | 100 | >99.9 | >99.9 | >99.9 |
| 6 | 100 | >99.9 | 69.2 (91.9) | >99.9 |

| | Small intestine | | | | |
|---|---|---|---|---|---|
| | Trichostrongylus | Cooperia spp | Cooperia spp | Cooperia spp | Nematodirus |
| Group No. | spp (adult) | (adult) | (immature) | L4 | spp (adult) |
| 1 | 94.4 | 88.5 (96.7) | >99.9 | 92.3 (85.9) | negative |
| 2 | 54.9 (negative) | 56.1 (66.4) | >99.9 | >99.9 | negative |
| 3 | 85.9 (84.9) | 91.4 (88.3) | >99.9 | >99.9 | 50 (18.5) |
| 4 | 57.7 (93.8) | 80.2 (84.3) | >99.9 | >99.9 | 25 (8) |
| 5 | 92.5 (96.1) | 89.8 (98.7) | >99.9 | >99.9 | >99.9 |
| 6 | 91.5 (88.3) | 36.3 (83.6) | >99.9 | 53.8 (75.8) | >99.9 |

| | Large intestine | |
|---|---|---|
| Group No. | Oesophagostomum (adult) | Trichuris (adult) |
| 1 | >99.9 | 99.9 (>99.9) |
| 2 | >99.9 | 14.3 (negative) |
| 3 | >99.9 | 99.9 (>99.9) |
| 4 | >99.9 | 99.9 (>99.9) |
| 5 | >99.9 | 85.7 (71.2) |
| 6 | >99.9 | 85.7 (71.2) |

### Example 5.2

Two critical slaughter studies were designed to compare the efficacy of a formulation according to the invention (see below) against immature and adult stages of the liver fluke Fasciola hepatica, and naturally acquired roundworm infections in cattle. The efficacy of the triclabendazole+ivermectin pour-on against immature and mature stages of Fasciola hepatica based on arithmetic mean was 70.5% and 99.2% respectively. Control of gastrointestinal strongyles by the test formulation (Group 5, Example 5.1, Table 8) as assessed using total worm counts at slaughter was 86% to 99.9% (arithmetic mean) for nematodes found in the abomasum, small and large intestines.

Test formulation—described in Example 1.1, Formulation A

| Component | g or mL/L | Dose Rate (mg/kg) |
|---|---|---|
| Triclabendazole | 240 g | 24.0 |
| Ivermectin | 7.5 g | 0.75 |
| Ecoteric T20 ® | 200 g | |
| PEG 200 | 30 g | |
| Water | 150 g | |
| Brilliant Blue FCF | 0.16 g | |
| Sodium dodecyl sulphate | 20 g | |

| | |
|---|---|
| Butyl diGlysolv ® | approximately 475 mL |
| | (to volume) |

### Example 5.3

Three field trials (faecal egg count reduction tests) were designed to determine the efficacy of the formulation described in Example 5.2 under field conditions. Sixty cattle were split into groups of 15, one of the groups remaining as an untreated control. Good efficacy of the formulation against Fasciola hepatica as assessed by a reduction in faecal egg counts as compared to the untreated controls of >90% (AM) was reported in all trials 14 days post treatment.

### Example 5.4

A field trial was designed to determine the efficacy of the following formulation against a mixed natural infection of adult and immature liver flukes and adult and immature nematode species.

| Component | g/L | Dose Rate (mg/kg) |
|---|---|---|
| Triclabendazole | 240 g | 24.0 |
| Ivermectin | 7.5 g | 0.75 |
| Ecoteric T20 ® | 200 g | |
| PEG 200 | 30 g | |
| Water | 150 g | |
| Brilliant Blue FCF | 0.16 g | |
| Sodium dodecyl sulphate | 20 g | |

| | |
|---|---|
| Butyl diGlysolv ® | approximately 450 mL |
| | (to volume) |

Thirty (30) Angus cross and Limousin cross weaners, between 5 and 6 months of age, and weighing 112-242 kg, were selected from a larger commercial herd running at Armidale, New South Wales, Australia, on the basis of pre trial individual strongyle egg counts. The cattle grazed in open paddocks on a mixture of native and improved pasture with supplementary feed (buckwheat) provided on a daily basis. Over the treatment period at the Armidale Saleyards cattle had ad-lib access to Lucerne hay. The cattle had not been exposed to any anthelmintic treatments for a period of three (3) months prior to the trial start date.

Prior to treatment cattle were ranked from highest to lowest on individual pre trial liver strongyle faecal egg counts (Day-3), split into females and castrated males, blocked and randomly allocated to two (2) treatment groups such that the groups had a similar mean and range of strongyle faecal egg counts within the group. On day zero (0), all trial cattle were weighed and vaccinated with UltraVac 7 in 1 Vaccine (CSL Limited). The animals of Group 1 were left untreated, serving as negative controls. Group 2 was treated with the triclabendazole (240 g/L)+ivermectin (7.5 g/L) pour on formulation applied topically from the middle of the back to the base of the tail at a dose volume of 1 mL/10 kg. A prototype applicator which ensured the formulation was applied as a wide band was used for treatment.

Faecal samples were collected from all trial cattle on day zero (0) and on days seven (7) fourteen (14) twenty one (21) and twenty eight (28) of the trial. Strongyle and liver fluke faecal egg counts and group bulk coprocultures for larval differentiation were performed on samples collected. Raw strongyle and fluke faecal egg counts were collated by treatment group and arithmetic means calculated. Geometric means were also calculated using transformed individual egg counts. Treatment efficacy, based on both arithmetic and geometric group means were calculated as follows:
% Efficacy=(control group mean−treatment group mean)/control group mean×100

Pre treatment Fasciola and strongyle faecal egg counts were high, with a mean Strongyle faecal egg count of 802.7 e.p.g. (range 160-6120) and a mean Fasciola faecal egg count of 46 e.p.g. (range 0-1525) pre trial. Five genera of helminths were identified from group bulk coprocultures including: Haemonchus spp., Trichostrongylus spp., Ostertagia spp., Cooperia spp and Oesophagostomum spp. Cooperia spp made up on average 70% of the bulk coproculture for the untreated controls from day 0 to day 28. Group arithmetic and geometric mean Fasciola faecal egg counts over the duration of the trial are presented in Table 9. Good control (>90% efficacy arithmetic mean, >97% efficacy geometric mean) of Fasciola hepatica was achieved with the triclabendazole+ivermectin pour on, 7, 14, 21 and 28 days post treatment. Treatment efficacies based on arithmetic and geometric mean fluke faecal egg counts are presented in Table 10.

TABLE 9
Fasciola faecal egg counts
(e.p.g—eggs per gram; Arithmetic mean—AM; Geometric mean—GM)

| | Day 0 | | Day 7 | | Day 14 | | Day 21 | | Day 28 | |
|---|---|---|---|---|---|---|---|---|---|---|
| Group No. | AM | GM | AM | GM | AM | GM | AM | GM | AM | GM |
| 1 (control) | 58.4 | 44.3 | 86.7 | 44.6 | 86.3 | 55 | 49.1 | 28.6 | 64.2 | 23.8 |
| 2 | 159 | 47.2 | 1.4 | 0.4 | 6.8 | 1.3 | 2.6 | 0.3 | 3.3 | 06 |

TABLE 10
Treatment Efficacy using arithmetic mean (AM) and geometric
mean (GM) fluke faecal egg counts
(percent reduction from untreated controls)

| Day 7 | | Day 14 | | Day 21 | | Day 28 | |
|---|---|---|---|---|---|---|---|
| AM | GM | AM | GM | AM | GM | AM | GM |
| 98.4 | 99.2 | 92.2 | 97.7 | 94.6 | 99.0 | 94.8 | 97.5 |

Group arithmetic and geometric mean strongyle faecal egg counts over the duration of the trial are presented in Table 11. Efficacy of the triclabendazole+ivermectin pour on against strongyles was greater than 93% (geometric means) 7 and 28 days post treatment, and 89.8% and 83.5% 14 and 21 days post treatment. Efficacy based on arithmetic and geometric faecal egg counts are presented in Table 12.

TABLE 11
Strongyle faecal egg counts
(e.p.g—eggs per gram; Arithmetic mean—AM; Geometric mean—GM)

| | Day 0 | | Day 7 | | Day 14 | | Day 21 | | Day 28 | |
|---|---|---|---|---|---|---|---|---|---|---|
| Group No. | AM | GM | AM | GM | AM | GM | AM | GM | AM | GM |
| 1 (control) | 501 | 601 | 333 | 137.3 | 163 | 93.6 | 136 | 64.9 | 173 | 138.4 |
| 2 | 747 | 891 | 112 | 4.5 | 90.0 | 9.6 | 54.3 | 10.7 | 60.0 | 0.6 |

TABLE 12
Treatment Efficacy using arithmetic mean (AM) and
geometric mean (GM) strongyle faecal egg counts
(percent reduction from untreated controls)

| Day 7 | | Day 14 | | Day 21 | | Day 28 | |
|---|---|---|---|---|---|---|---|
| AM | GM | AM | GM | AM | GM | AM | GM |
| 66.4 | 96.7 | 44.7 | 89.8 | 60.1 | 83.5 | 65.4 | 93.4 |

### Example 5.5

A further field trial was designed to determine the efficacy of the formulation described in Example 5.4 against a mixed natural infection of adult and immature liver flukes and adult and immature nematode species.

Thirty (30) Angus and Angus cross heifers, between 12 and 14 months of age, and weighing 126-284 kg, were selected from a larger commercial herd running at Walcha, New South Wales, Australia, on the basis of pre trial individual strongyle egg counts. The cattle grazed in open paddocks on a mixture of native and improved pasture with ad-lib access to water. The cattle had not been exposed to any anthelmintic treatments for a period of three (3) months prior to the trial start date.

Prior to treatment cattle were ranked from highest to lowest on individual pre trial liver strongyle faecal egg counts (Day-1), blocked and randomly allocated to two (2) treatment groups such that the groups had a similar mean and range of strongyle faecal egg counts within the group. On day zero (0), all trial cattle were weighed. The animals of Group 1 were left untreated, serving as negative controls. Group 2 was treated with the triclabendazole (240 g/L)+ivermectin (7.5 g/L) pour on formulation applied topically from the middle of the back to the base of the tail at a dose volume of 1 mL/10 kg. A prototype applicator which ensured the formulation was applied as a wide band was used for treatment.

Faecal samples were collected from all trial cattle on day zero (0) and on days seven (7) fourteen (14) twenty one (21) and twenty nine (29) of the trial. Strongyle faecal egg counts and group bulk coprocultures for larval differentiation were performed on samples collected. Raw strongyle egg counts were collated by treatment group and arithmetic means calculated. Geometric means were also calculated using transformed individual egg counts. Treatment efficacy, based on both arithmetic and geometric group means were calculated as follows:
% Efficacy=(control group mean−treatment group mean)/control group mean×100

Pre treatment strongyle faecal egg counts were high, with a mean Strongyle faecal egg count of 288 e.p.g. (range 40-1320). Four genera of helminths were identified from group bulk coprocultures at day zero (0) including: Haemonchus spp., Ostertagia spp., Cooperia spp and Oesophagostomum spp. Cooperia spp made up on average 70-80% of the bulk coproculture for the untreated controls from day 0 to day 29. Group arithmetic and geometric mean strongyle faecal egg counts over the duration of the trial are presented in Table 13. Efficacy of the triclabendazole+ivermectin pour on against strongyles reached a maximum 84% reduction in egg counts (arithmetic means) 7 days post treatment, and 78%, 59% and 63% 14, 21 and 29 days post treatment. Treatment efficacies based on arithmetic and geometric strongyle egg counts are presented in Table 14.

TABLE 13
Strongyle faecal egg counts
(e.p.g—eggs per gram; Arithmetic mean—AM; Geometric mean—GM)

| | Day 0 | | Day 7 | | Day 14 | | Day 21 | | Day 28 | |
|---|---|---|---|---|---|---|---|---|---|---|
| Group No. | AM | GM | AM | GM | AM | GM | AM | GM | AM | GM |
| 1 (control) | 344 | 262 | 203 | 95 | 267 | 175 | 216 | 129 | 208 | 116 |
| 2 | 379 | 273 | 32 | 2 | 59 | 22 | 88 | 21 | 77 | 26 |

TABLE 14
Treatment Efficacy using arithmetic mean (AM) and
geometric mean (GM) strongyle faecal egg counts
(percent reduction from untreated controls)

| Day 7 | | Day 14 | | Day 21 | | Day 28 | |
|---|---|---|---|---|---|---|---|
| AM | GM | AM | GM | AM | GM | AM | GM |
| 84.2 | 98.2 | 78 | 87.5 | 59.3 | 83.6 | 62.8 | 77.4 |

### Example 5.6

A dose evaluation critical slaughter study was designed to compare the pharmacokinetics and efficacy of the developmental topical triclabendazole+ivermectin formulation described in Example 5.4 (240 g/L triclabendazole and 7.5 g/L ivermectin), and the developmental topical triclabendazole+ivermectin formulations of formulae F (240 g/L triclabendazole and 10 g/L ivermectin) and G (240 g/L triclabendazole and 15 g/L ivermectin) described in Examples 1.6 and 1.7 respectively against a mixed natural infection of gastrointestinal strongyles, so as to determine the optimum concentration of ivermectin in the formulation for effective control of Cooperia spp as well as the other nematodes.

Fifty (50) Hereford and Angus cross steers, aged between five to six (5-6) months and weighing between 102-164 kg at treatment, were selected from a larger mob at Casino on the North Coast of NSW, Australia on the basis of pre trial individual strongyle faecal egg counts. The cattle were relocated to “Kirby”, Armidale NSW, Australia twenty days prior to treatment and grazed in open paddocks on a mixture of native and improved pastures. Trial cattle were fed Lucerne hay while they were held in the Armidale Saleyards (day 0 through to day 2). The cattle had not been exposed to triclabendazole or ivermectin for a period of three (3) months prior to the trial start date and had no known resistance by gastrointestinal strongyles to macrocyclic lactones.

Five (5) days prior to treatment faecal samples were collected from each animal for individual faecal egg counts and bulk coproculture. Triplicate blood samples were collected for triclabendazole and ivermectin plasma analysis. One (1) day prior to treatment Twenty five (25) trial cattle were re-located to the Armidale Saleyards, ranked from highest to lowest according to individual egg counts (day-5), sequentially blocked and allocated at random to five (5) groups of five (5) animals, such that each group had a similar mean and range of strongyle faecal egg counts. The animals of Group 1 were left untreated, serving as negative controls. Group 2 was treated with the 240 g/L triclabendazole+7.5 g/L ivermectin pour on formulation. Group 3 was treated with the 240 g/L triclabendazole+10.0 g/L ivermectin pour on formulation. Group 4 was treated with the 240 g/L triclabendazole+15.0 g/L ivermectin pour on formulation. All formulations were applied topically from the middle of the back to the base of the tail at a dose volume of 1 mL/10 kg (according to a dose break table). A prototype applicator which ensured the formulation was applied as a wide band was used for treatment. Two (2) day after treatment all cattle were re-located from the Armidale Saleyards to the Kirby feedlot for the remainder of the trial.

Faecal samples were collected from each individual animal in all groups five (5) days prior to treatment then nine (9) for individual faecal egg counts and coprocultures pre and post treatment. All trial cattle were sacrificed 13, 14 and 15 days post treatment. Faecal samples, abomassa, small intestine and large intestine were collected from each animal for faecal egg counts, group coprocultures and total worm counts (adult and immature). Treatment efficacy was assessed by comparison of group arithmetic and geometric mean total worm counts (as described in Examples 5.4 and 5.5) by nematode species and strongyle faecal egg counts following sacrifice and organ recovery.

Pre treatment egg counts were generally high ranging from 480-1480 eggs per gram (e.p.g.) of faeces.

At 13-15 days post treatment, animals treated with the pour-on formulations produced a reduction in egg counts when compared to the untreated controls of between 73% (240 g/L triclabendazole plus 7.5 g/L ivermectin) to 98% (240 g/L triclabendazole plus 15.0 g/L ivermectin) (arithmetic means) and between 94% and >99% respectively (geometric means). (Table 15).

TABLE 15
Treatment efficacies at Days 9 and 13, 14, 15, as assessed
using arithmetic and geometric group mean faecal egg counts.

| | | | |
|---|---|---|---|
| | | EPG | EPG |
| Group | Treatment | Day 9 | Days 13-15 |

Arithmetic data

| | | | |
|---|---|---|---|
| 2 | IVM 7.5 mg/mL + TCBZ 240 mg/mL | 82.8% | 72.8% |
| 3 | IVM 10 mg/mL + TCBZ 240 mg/mL | 95.4% | 89.1% |
| 4 | IVM 15 mg/mL + TCBZ 240 mg/mL | 97.7% | 97.5% |

Geometric data

| | | | |
|---|---|---|---|
| 2 | IVM 7.5 mg/mL + TCBZ 240 mg/mL | 96.7% | 93.9% |
| 3 | IVM 10 mg/mL + TCBZ 240 mg/mL | 99.3% | 98.3% |
| 4 | IVM 15 mg/mL + TCBZ 240 mg/mL | 99.5% | 99.7% |

IVM—ivermectin,
TCBZ—triclabendazole,
epg—eggs per gram

At necropsy, seven (7) genera of helminths were recovered from the gastrointestinal tract of the control cattle approximately 80% of which consisted of adult, immature and L4 stages of Cooperia spp. Other gastrointestinal nematodes identified include Trichuris spp, Nematodirus spp, Oesophagosomum spp. Trichostrongylus spp, Haemonchus spp and Ostertagia spp which each made up approximately 5% or less of the total count.

Total worm count data indicated that the small intestinal worms, Cooperia spp. and adult Nematodirus spp., were the most difficult species to remove following treatment. Efficacy increased with increasing concentration of ivermectin in the formulation.

The 240 g/L triclabendazole plus 15.0 g/L ivermectin formulation efficacy against adult and immature stages of small intestinal nematodes (Trichostrongylus spp, Cooperia spp) was greater than 90% (arithmetic and geometric means) and greater than 99% (geometric means) with the exception of adult Nematodirus [49.1% (arithmetic means) and 93% (geometric means)].

Greater than 95% efficacy (geometric and arithmetic) was achieved against adult and immature stages of abomasal nematodes (Haemonchus spp, Ostertagia ostertagia, Trichostrongylus axei) and large intestinal nematodes (Oesphagostomum spp, Trichuris spp).

Greater than 95% efficacy (arithmetic and geometric means) was achieved by the 240 g/L triclabendazole plus 7.5 g/L ivermectin and the 240 g/L triclabendazole plus 10 g/L ivermectin formulations against abomasal nematodes (with the exception of fourth stage Ostertagia larvae in cattle treated with the 240 g/L triclabendazole plus 10 g/L ivermectin formulation). Efficacy against small intestinal nematodes increased from 57.7% to greater than 99.9% with increased concentration of ivermectin.

TABLE 16
Arithmetic/Geometric mean and percentage removal of the
number of helminths recovered at necropsy from 15 g/L
ivermectin + 240 g/L triclabendazole treated animals

| | 15 g/L Ivermectin + 240 g/L Triclabendazole | | | | | |
|---|---|---|---|---|---|---|
| | Removal % (AM) | | | Removal % (GM) | | |
| Helminth species | Adult | Immature | L4 | Adult | Immature | L4 |
| Abomasal | | | | | | |
| Haemonchus spp. | 96 | >99.9 | | 99.1 | >99.9 | |
| Ostertagia spp. | >99.9 | >99.9 | >99.9 | >99.9 | >99.9 | >99.9 |
| Trichostrongylus | >99.9 | | | >99.9 | | |
| axei | | | | | | |
| Small Intestine | | | | | | |
| Trichostrongylus | >99.9 | | | >99.9 | | |
| spp. | | | | | | |
| Cooperia spp. | 90.7 | 94.6 | >99.9 | 99.5 | 99.5 | >99.9 |
| Nematodirus spp. | 44.9 | | | 93.3 | | |
| Large Intestine | | | | | | |
| Oesphagostomum | >99.9 | >99.9 | | >99.9 | >99.9 | |
| spp. | | | | | | |
| Trichuris spp. | >99.9 | >99.9 | | >99.9 | >99.9 | |

Triplicate blood samples were also collected five (5) days prior to treatment then 1, 3, 5 and 7 days post treatment from animals in groups 2, 3, 4 and 5 for triclabendazole and ivermectin analysis. Plasma ivermectin Cₘₐₓ and AUC values increased relative to the concentration in the formulation—Table 17.

TABLE 17
Summary (mean +/− SD) disposition of ivermectin by treatment group

| | Cₘₐₓ | | |
|---|---|---|---|
| Treatment group | (ng/mL) | Tₘₐₓ (day) | AUC (ng · d/mL) |
| Grp 2: IVM 7.5 mg/mL + | 3.75 ± 2.22 | 3.4 ± 1.7 | 13.39 ± 5.88 |
| TCBZ 240 mg/mL | | | |
| Grp3: IVM 10 mg/mL + | 9.00 ± 7.74 | 3.8 ± 1.1 | 26.65 ± 22.56 |
| TCBZ 240 mg/mL | | | |
| Grp 4: IVM 15 mg/mL + | 6.95 ± 2.87 | 3.8 ± 1.1 | 31.87 ± 17.13 |
| TCBZ 240 mg/mL | | | |

IVM—ivermectin,
TCBZ—triclabendazole

Summary:

For a given dose volume (1 mL per 10 kg bodyweight), increasing the concentration of ivermectin in the formulation increased the plasma concentration and efficacy. Nematode efficacy of the 240 g/L triclabendazole plus 15.0 g/L ivermectin was higher and more consistent than the corresponding formulations containing 7.5 and 10.0 g/L ivermectin, especially against the hard to control small intestinal worms, Cooperia spp and Nematodirus spp.

### INDUSTRIAL APPLICABILITY

The formulations of the invention can be readily used to treat, control or prevent disease caused by, and/or infestations of, endo-parasites such as liver fluke and nematodes as well as ecto-parasites, particularly in treating, controlling and/or preventing liver fluke and nematode infestations in sheep or cattle, particularly cattle.

It will be appreciated that, although specific embodiments of the invention have been described herein for the purpose of illustration, various modifications may be made without deviating from the spirit and scope of the invention as defined in the following claims.

1. An aqueous micellar formulation for topical application to animals for the control of internal parasites comprising a first active agent in combination with a second active agent, and:
from about 100 g to about 400 g veterinary-acceptable surfactant(s) per litre of formulation;
from about 200 g to about 750 g veterinary-acceptable water-miscible to solvent(s) per litre of formulation; and
from about 50 g to about 350 g of water per litre of formulation;
wherein said first active agent is selected from the group consisting of water insoluble benzimidazoles, salicylanilides, active derivatives thereof, and salts thereof; and
wherein said second active agent is selected from the group consisting of macrocyclic lactones, active derivatives thereof, and salts thereof.

2. A formulation according to claim 1, wherein said surfactant is selected from polyoxyethylene sorbitan- or sorbitol-fatty acid esters or combinations thereof.

3. A formulation according to claim 2, wherein said surfactant is polyoxyethylene (20) sorbitan monolaurate.

4. A formulation according to claim 1, wherein said water miscible solvent is selected from the group consisting of ethanol, isopropanol, benzyl alcohol, glycol ethers, liquid polyoxyethylene glycols, and a mixture of at least two of these solvents.

5. A formulation according to claim 4, wherein one or more of the glycol ethers are selected from alkylene or dialkylene glycol monoalkyl ethers.

6. A formulation according to claim 5, wherein said one or more of glycol ethers are selected from the group consisting of propylene glycol monomethyl ether, diethylene glycol monoethyl ether, and diethylene glycol monobutyl ether.

7. A formulation according to claim 4, comprising a glycol ether and a liquid polyethylene glycol as water-miscible solvents.

8. A formulation according to claim 7, wherein the polyethylene glycol is PEG 200.

9. A formulation according to claim 1, further comprising from about 5 g to about 50 g per litre of formulation of a stabilizer selected from linear anionic surfactants, buffering agents and mixtures thereof.

10. A formulation according to claim 9, wherein said stabilizer is selected from the group consisting of linear alkyl sulphates, linear alkyl benzene sulphonates, and phosphates, or mixtures thereof.

11. A formulation according to claim 10, wherein said stabilizer is sodium dodecyl sulphate.

12. A formulation according to claim 1, comprising about 100 g to about 300 g surfactant per litre of formulation.

13. A formulation according to claim 1, comprising from about 300 g to about 650 g water-miscible solvent(s) per litre of formulation.

14. A formulation according to claim 1, wherein said formulation comprises from about 10 g to about 100 g per litre of formulation of a liquid polyethylene glycol as a water-miscible solvent.

15. A formulation according to claim 13, comprising about 450 g to about 550 g glycol ether(s) selected from alkylene or dialkylene glycol monoalkyl ethers, and about 20 g to about 50 g of a liquid polyethylene glycol as the one or more water-miscible solvents per litre of formulation.

16. A formulation according to claim 1, comprising about 150 g water per litre of formulation.

17. A formulation according to claim 1, comprising from about 120 g to about 300 g benzimidazole, or a derivative thereof, per litre of formulation.

18. A formulation according to claim 16, wherein said first active agent is triclabendazole.

19. A formulation according to claims 1, comprising from about 7.5 g to about 20 g macrocyclic lactone per litre of formulation.

20. A formulation according to claim 19, comprising about 15 g macrocyclic lactone per litre formulation.

21. A formulation according to claim 19, wherein said macrocyclic lactone is ivermectin.

22. A formulation according to claim 1, comprising, per litre of formulation:
about 180 g to about 240 g benzimidazole;
about 7.5 g to about 20 g macrocyclic lactone or an active derivative or salt thereof;
about 150 g to about 250 g polyoxyethylene (20) sorbitan monolaurate;
about 450 g to about 550 g diethylene glycol monobutyl ether;
about 20 g to about 50 g PEG 200;
about 10 g to about 30 g sodium dodecyl sulphate; and
about 100 g to about 200 g of water.

23. The formulation of claim 22 which comprises about 240 g triclabendazole and about 15 g ivermectin per litre.

24. A method of treating or preventing a diseased or parasite-infested state in a mammal, comprising topically administering to said mammal a micellar formulation according to claim 1, wherein said disease or parasite-infested state comprises a liver fluke infection or infestation, a nematode infection or infestation, or both a liver fluke and a nematode infection or infestation in a said mammal.

25. A method according to claim 24, wherein said mammal is selected from the group consisting of cattle, sheep, goats, pigs and horses.

26. A method according to claims 24, wherein said topical application comprises application of the formulation in a band along the lower portion of the back of the mammal.

27. A method according to claim 26, wherein the formulation is applied to the mammal over as small a region as possible, while avoiding run-off of the formulation so as to maximise the concentration of active agents per cm² of animal surface.

28. A method according to claim 26, wherein the band of formulation is applied starting from the thoracic vertebrae and proceeding towards the rump of to the animal, and from about 18 mg to about 24 mg triclabendazole and from about 0.75 mg to about 2 mg ivermectin are applied per kilogram animal.

29. The method of claim 28, wherein about 24 mg triclabendazole and about 15 mg ivermectin are applied per kilogram animal.
